(19) United States
(12) Patent Application Publication
(10) Pub. No.: US 2025/0164671 A1
(43) Pub. Date: May 22, 2025

(54) LARGE-AREA TRANSPARENT REFLECTIVE PANEL USING NANOCLUSTERS AND METHOD FOR MANUFACTURING THE SAME

(71) Applicants: KOREA INSTITUTE OF MACHINERY & MATERIALS, Daejeon (KR); CENTER FOR ADVANCED META-MATERIALS, Daejeon (KR)

(72) Inventors: Jun-ho JEONG, Daejeon (KR); Soon-Hyoung HWANG, Daejeon (KR); Sohee JEON, Seoul (KR); Yongrok JEONG, Daejeon (KR); Zhijun ZHAO, Busan (KR); Hyeok Jung KANG, Daejeon (KR)

(21) Appl. No.: 18/836,209

(22) PCT Filed: May 25, 2023
(86) PCT No.: PCT/KR2023/007184

§ 371 Date: Aug. 6, 2024

(30) Foreign Application Priority Data
May 25, 2022 (KR) 10-2022-0063927

(51) Int. Cl. G02B 5/02; B29C 33/42; B29C 33/44

(52) U.S. Cl. CPC G02B 5/0284; B29C 33/424; B29C 33/44; G02B 5/0215; G02B 5/0268; G02B 5/0289; G02B 2207/101

(57) ABSTRACT

A large-area transparent reflective panel using nanoclusters and method for manufacturing the transparent reflective panel. The transparent reflective panel includes a light transmissive medium and a plurality of metal clusters formed on the light transmissive medium. Each of the metal clusters includes unit metal bodies spaced apart from each other and formed on the light transmissive medium.

### BACKGROUND

### 1. Field of Disclosure

The present disclosure of invention relates to a large-area transparent reflective panel using nanoclusters and method for manufacturing the same, and more specifically the present disclosure of invention relates to a large-area transparent reflective panel having a scattering function by arranging clusters of nano-scale unit metal bodies on a large-area glass substrate, and method for manufacturing the large-area transparent reflective panel.

### 2. Description of Related Technology

In general, a transparent reflective panel means a reflective display in which the surrounding background is identified through a transparent panel, and the projected image of the projector is scattered at the same time.

Here, the transparent reflective panel includes micro-scale structures, and the micro-scale structures can scatter the projected image on a transparent medium, so the scattering angle of the transparent reflective panel is small. In the conventional translucent film, the amount of reflection for a specific angle may be increased by using a micro diffraction grating, but the scattering angle is small and thus the conventional translucent film may be hard to be functioned as a screen.

Thus, may studies have been conducted on the transparent reflective panel that may increase the scattering angle, such as in Korea Patent No. 10-0949870, but satisfactory results have not yet been obtained.

### SUMMARY

The present invention is developed to solve the above-mentioned problems of the related arts. The present invention provides a large-area transparent reflective panel capable of increasing a scattering angle in an entire visible light range.

In addition, the present invention also provides method for manufacturing the large-area transparent reflective panel.

According to an example embodiment, the transparent reflective panel includes a light transmissive medium and a plurality of metal clusters formed on the light transmissive medium. Each of the metal clusters includes unit metal bodies spaced apart from each other and formed on the light transmissive medium.

In an example, the metal clusters may be arranged with the same distance along a first direction (X) and a second direction (Y) perpendicular to the first direction.

In an example, a distance between the metal clusters adjacent to each other may be between about 100 nm and about 10 mm.

In an example, each of the metal clusters may have a boundary, and the unit metal bodies may be arranged within the boundary of the metal cluster.

In an example, the boundary of the metal cluster may have a round shape.

In an example, a size of the round shape of the boundary may be between about 50 nm and about 5 mm.

In an example, the unit metal bodies may be arranged randomly inside of the boundary.

In an example, a size of each of the unit metal bodies may be between about 10 nm and 10 μm.

According to another example embodiment, in a method for manufacturing a transparent reflective panel, a resin is coated on a mold in which a plurality of protrusions is formed on a plate, to cover the protrusions. A film is formed on a first surface of the resin. The mold is detached from the resin, after solidifying the resin. A first metal layer is formed on a second surface of the resin which is exposed to outside as the mold is separated. The first metal layer is pressurized on a second metal layer formed on a light transmissive medium. The light transmissive medium is heat-treated to melt the second metal layer. The light transmissive medium is removed to remain the second metal layer on the first metal layer.

In an example, the first meal layer may include gold (Au), and the second metal layer may include silver (Ag).

In an example, each of the protrusions may have a cylinder shape.

In an example, the protrusions may be arranged with the same distance along a first direction (X) and a second direction (Y) perpendicular to the first direction from a first surface of the plate.

In an example, the film may include polyethylene terephthalate (PET).

In an example, in the heat-treating the light transmissive medium to melt the second metal layer, the second metal layer making contact with the first metal layer may be melted to be attached to the first metal layer.

In an example, as the mold is detached from the resin, a plurality of space portions may be formed in the resin by the protrusions.

In an example, in the forming a first metal layer on a second surface of the resin, the first metal layer may be formed in the space portions of the resin.

In an example, in the heat-treating the light transmissive medium to melt the second metal layer, the second metal layer facing the first metal layer formed in the space portions may be melted to be formed as unit metal bodies in the light transmissive medium.

In an example, the unit metal bodies may be arranged to be spaced apart from each other in the light transmissive medium, as the space portions are spaced apart from each other.

According to the present example embodiments, a large-area transparent reflective panel capable of increasing a scattering angle in an entire visible light range may be manufactured.

### BRIEF DESCRIPTION OF THE DRAWINGS

FIG. 1 is a plan view illustrating a transparent reflective panel according to an example embodiment of the present invention; and

FIG. 2A to FIG. 2F are process views illustrating a method for manufacturing the transparent reflective panel of FIG. 1.

* Reference numerals

| | |
|---|---|
| 10: light transmissive medium | 100: metal cluster |
| 110: unit metal body | 210: mold |
| 220: resin | 230: film |
| 240: first metal layer | 250: second metal layer |

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. Spatially relative terms, such as “beneath,” “below,” “lower,” “above,” “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention is described more fully hereinafter with reference to the accompanying drawings, in which embodiments of the invention are shown.

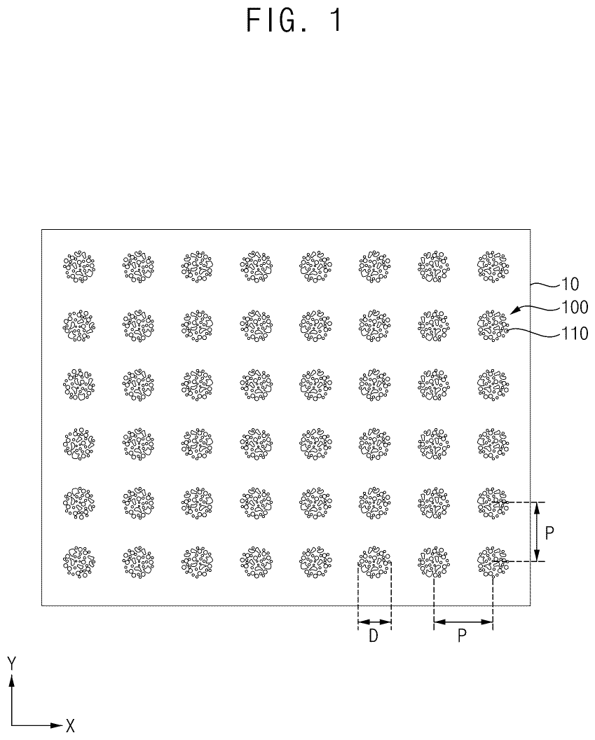

FIG. 1 is a plan view illustrating a transparent reflective panel according to an example embodiment of the present invention.

The transparent reflective panel according to the present example embodiment includes a light transmissive medium 10 and a plurality of metal clusters 100 formed on the light transmissive medium 10.

Here, the light transmissive medium 10 may include a glass, but, the light transmissive medium 10 may not be limited to thereto and the light transmissive medium 10 may include a material having a light transmissivity and whose physical properties and shape do not change during a heat treatment.

Each of the metal clusters 100 include unit metal bodies 110 which are spaced apart from each other and formed on the light transmissive medium 10. Here, each of the unit metal bodies 100 has a randomly determined shape, and may include sliver (Ag). The shape of the unit metal body 110 is obtained via a heat treatment process explained below, and an individual shape of the unit metal bodies may be randomly determined via the heat treatment process.

The metal clusters 100 are arranged with the same distance P along a first direction X and a second direction Y perpendicular to the first direction X, and thus the metal clusters 100 may have a square shape as a whole.

Alternatively, the distance along the first direction X may be different from that along the second direction Y, and thus the metal clusters 100 may have a rectangular shape as a whole.

The metal cluster 100, as illustrated in the figure, has a boundary having a predetermined shape, and here the boundary may have a various kinds of randomly shapes. The boundary may have a closed shape forming a predetermined area inside of the boundary.

In addition, the randomly shape of the metal cluster 100 may be a round shape, and more specifically may be a circular shape boundary. Here, even though the metal cluster 100 has the circular shape boundary, the circular shape boundary may not be the same as a complete circle and may be enough to have a roughly circular boundary, since the unit metals bodies 110 included inside of the metal cluster 100 do not have a uniform shape.

As explained above, the metal unit bodies 110 may be arranged inside of the circular shape boundary. A diameter of the circle in the circular shape boundary may be determined by a diameter of a protrusion 213 explained below in a method. Here, the unit metal bodies 110 may be randomly arranged inside of the circular shape boundary.

The metal clusters 100 may be arranged at equal intervals P in the range of about 100 nm to 10 mm in each of the first and second directions. A size D of the round shape boundary of the metal cluster 100 may be between about 50 nm and about 5 mm, and a size of the unit metal body 110 may be between 10 nm and about 10 μm.

Here, the size of the unit metal body 110 may be calculated by a middle value between the maximum and minimum values measured by a straight line distance, and the maximum value may be also used.

Accordingly, since the metal cluster 100 includes the unit metal bodies 110 which are nano-particles, a scattering angle caused by the metal cluster 100 which causes resonance in the visible light band is widened by plasmonic resonance, so that the scattering angle may be increased in the entire visible light band.

Hereinafter, a method for manufacturing the transparent reflective panel is explained in detail.

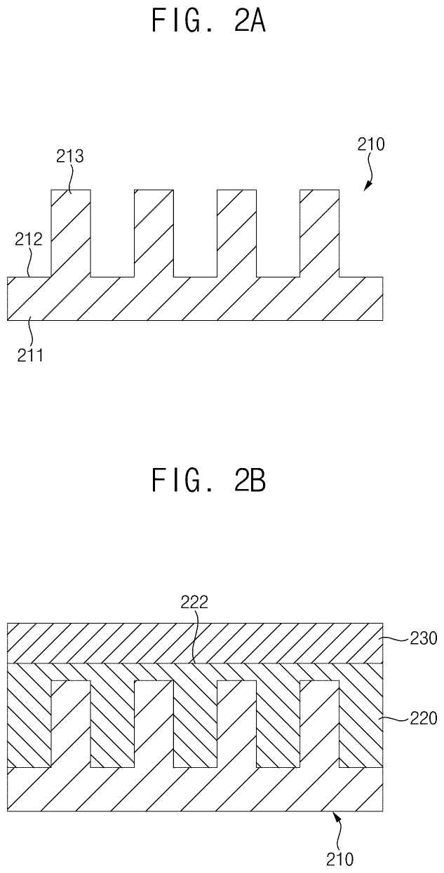

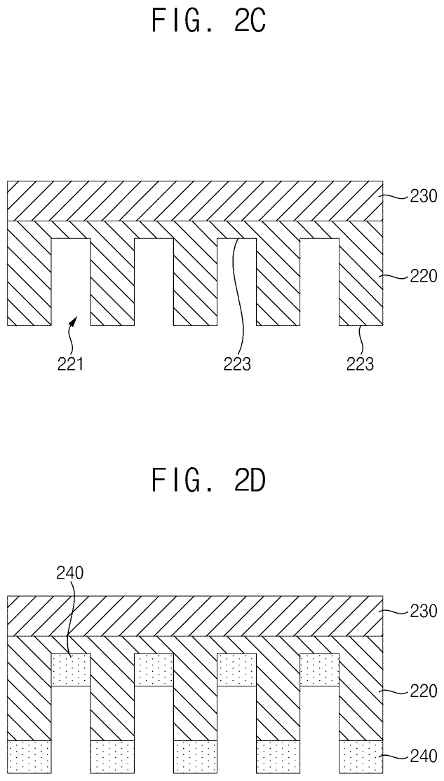

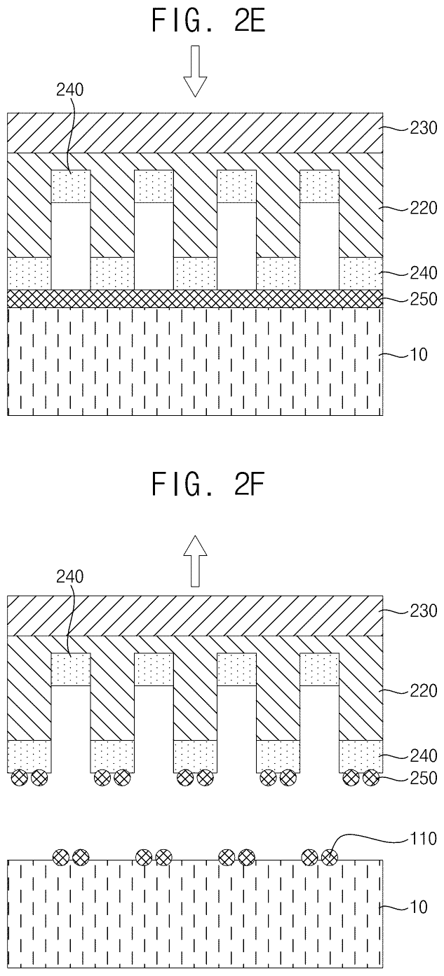

FIG. 2A to FIG. 2F are process views illustrating a method for manufacturing the transparent reflective panel of FIG. 1.

Referring to FIG. 2A, a mold 210 is prepared. A plurality of protrusions 213 is formed on a first surface 212 of a plate 211 in the mold 210. Here, the first surface 212 is defined as an upper surface of the plate 211 in the figure.

Each of the protrusions 213 may have a cylindrical shape having a diameter D, and the protrusions 213 may be arranged at equal intervals P from each other in the first direction on the plane of the plate 211 and the second direction perpendicular to the first direction, as a whole. Here, the mold 210 may include a silicon material.

A height of each of the protrusions 213 may be varied, and it is sufficient if the height of a space portion 221 formed by the protrusion 213 may be formed so that a sufficient separation distance is formed between a first metal layer 240 and a second metal layer 250, as illustrated in FIG. 2E in the following process.

Then, referring to FIG. 2B, a resin 220 having a liquid state is coated on the first surface 212 of the mold 210, to cover the protrusions 213. Here, the resin 220 is coated to have a thickness larger than a height of the protrusion 213, and thus the resin 220 having a constant thickness is formed on the protrusion 213.

The resin 220 is solidified as time goes on. The resin 220 includes a second surface 223 making contact with the first surface 212 of the mold 210, and a first surface 222 opposite to the second surface 223, and in the figure, the first surface 222 is illustrated as an upper surface of the resin 220 and the second surface 223 is illustrated as a lower surface of the resin 220.

Then, referring to FIG. 2B, a film 230 is formed on the first surface 222 of the resin 220. The film 230 may include polyethylene terephthalate (PET) material, but not limited thereto. The film 230 may serve as a base substrate which maintains the shape of the resin 220 when the mold 210 is separated.

Then, referring to FIG. 2C, the mold 210 is detached from the solidified resin 220.

Accordingly, when the mold 210 is detached from the resin 220, the shapes of the protrusions 213 of the mold 210 are reversed and formed on the resin 220.

As illustrated in FIG. 2C, in case of the resin 220 from which the mold 210 is separated, a space portion 221 is formed in a recessed form by reflecting the protrusion shape of the protrusion 213. Here, the spacing between the space portions 221 may be substantially same as the spacing between the protrusions 213.

Then, referring to FIG. 2D, a first metal layer 240 is formed on the second surface 223 of the resin 220.

Here, the second surface 223 of the resin 220 corresponds to the surface where the space portions 221 are formed as the protrusions 213 are removed. Thus, when the first metal layer 240 is formed on the second surface 223 of the resin 220, as illustrated in the figure, the first metal layer 240 is formed on an externally protruding surface of the resin 220, and the second metal layer 240 is formed on an inner surface of the space portion 221 of the resin 220 at the same time.

The first metal layer 240 may include a material containing gold (Au) as its main ingredient, but not limited thereto. The first metal layer 240 may be attached to the resin 220 via a various kinds of methods such as a depositing, a coating and so on, and as explained above, the first metal layer 240 is filled in a bottom of the space portion 221 in the space portion 221.

Then, referring to FIG. 2E, apart from forming the first metal layer 240 on the resin 220, a second metal layer 250 is formed on a first surface 12 of the light transmissive medium 10. Here, the first surface 12 is illustrated as an upper surface of the light transmissive medium 10 in the figure. The second metal layer 250 may include a material containing silver (Ag) as its main ingredient, but not limited thereto.

Then, referring to FIG. 2E, the resin 220 is pressed toward the light transmissive medium 10.

Here, a surface of the resin 220 on which the first metal layer 240 is formed and a surface of the light transmissive medium 20 on which the second metal layer 250 is formed are arranged to face each other, and then the resin 220 pressed toward the light transmissive medium 10.

Thus, the first metal 240 formed on the second surface 223 of the resin 220 makes contact with the second metal layer 250 formed on the first surface 12 of the light transmissive medium 10, and then the first metal layer 240 presses the second metal layer 250.

In addition, with the pressing process, a heat-treating process is performed at the same time.

Due to the heat-treating process, the second metal layer 250 is melted to adhere to the first metal layer 240. In the process, an adhesive force between the first metal layer 240 and the second metal layer 250 increases more than that between the light transmissive medium 10 and the second metal layer 250.

Here, the second metal layer 250 may include silver (Ag) and the first metal layer 240 may include gold (Au), but the materials of the first metal layer 240 and the second metal layer 250 may be selected so that the melting point of the second metal layer 250 is lower than the melting point of the first metal layer 240.

In the heat-treating process, the second metal layer 250 which corresponds to the space portion 221 of the resin 220, faces the first metal layer 240 formed in the space portion 221 of the resin 220 and is spaced apart from the first metal layer 240 formed on the second surface 223, is melted on the light transmissive medium 10.

Then, as the second metal layer 250 is melted on the light transmissive medium 10, the second metal layer 250 is formed as the unit metal bodies 110 which are arranged in a random shape and spaced apart from each other.

Here, the unit metal bodies 110 may be formed inside of the diameter formed by the space portion 221. Since the diameter of the space part 221 is substantially same as the diameter of the protrusion 213 in the previous process, the diameter of the area in which the unit metal bodies 110 is substantially same as the range or the area of the protrusion 213.

Then, referring to FIG. 2F, the resin 220 is separated from the light transmissive medium 10 and is removed.

Here, as explained above, the adhesive force between the first metal layer 240 and the second metal layer 250 is increased more than the adhesive force between the second metal layer 250 and the light transmissive medium 10 due to the heat-treating process, and then the second metal layer 250 attached to the first metal layer 240 is detached from the light transmissive medium 10.

In addition, the second metal layer 250 melted on the light transmissive medium 10 which faces the space portion 221 remains on the light transmissive medium 10, and then the remained second metal layer 250 is formed to be the unit metal bodies 110.

Then, as illustrated in FIG. 1, the unit metal bodies 110 are formed on the light transmissive medium 10, and the shape and the arrangement of the unit metal bodies 110 are explained above.

According to the present example embodiments, a large-area transparent reflective panel capable of increasing a scattering angle in an entire visible light range may be manufactured.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A transparent reflective panel comprising:
a light transmissive medium; and
a plurality of metal clusters formed on the light transmissive medium,
wherein each of the metal clusters comprises unit metal bodies spaced apart from each other and formed on the light transmissive medium.

2. The transparent reflective panel of claim 1, wherein the metal clusters are arranged with the same distance along a first direction (X) and a second direction (Y) perpendicular to the first direction.

3. The transparent reflective panel of claim 2, wherein a distance between the metal clusters adjacent to each other is between about 100 nm and about 10 mm.

4. The transparent reflective panel of claim 2, wherein each of the metal clusters has a boundary, and the unit metal bodies are arranged within the boundary of the metal cluster.

5. The transparent reflective panel of claim 4, wherein the boundary of the metal cluster has a round shape.

6. The transparent reflective panel of claim 5, wherein a size of the round shape of the boundary is between about 50 nm and about 5 mm.

7. The transparent reflective panel of claim 4, wherein the unit metal bodies are arranged randomly inside of the boundary.

8. The transparent reflective panel of claim 1, wherein a size of each of the unit metal bodies is between about 10 nm and 10 μm.

9. A method for manufacturing a transparent reflective panel, the method comprising:
coating a resin on a mold in which a plurality of protrusions is formed on a plate, to cover the protrusions;
forming a film on a first surface of the resin;
detaching the mold from the resin, after solidifying the resin;
forming a first metal layer on a second surface of the resin which is exposed to outside as the mold is separated;
pressurizing the first metal layer on a second metal layer formed on a light transmissive medium;
heat-treating the light transmissive medium, to melt the second metal layer; and
removing the light transmissive medium, to remain the second metal layer on the first metal layer.

10. The method of claim 9, wherein the first meal layer comprises gold (Au), and the second metal layer comprises silver (Ag).

11. The method of claim 9, wherein each of the protrusions has a cylinder shape.

12. The method of claim 9, wherein the protrusions are arranged with the same distance along a first direction (X) and a second direction (Y) perpendicular to the first direction from a first surface of the plate.

13. The method of claim 9, wherein the film comprises polyethylene terephthalate (PET).

14. The method of claim 9, wherein in the heat-treating the light transmissive medium to melt the second metal layer,
the second metal layer making contact with the first metal layer is melted to be attached to the first metal layer.

15. The method of claim 9, wherein as the mold is detached from the resin, a plurality of space portions is formed in the resin by the protrusions.

16. The method of claim 15, wherein in the forming a first metal layer on a second surface of the resin,
the first metal layer is formed in the space portions of the resin.

17. The method of claim 16, wherein in the heat-treating the light transmissive medium to melt the second metal layer,
the second metal layer facing the first metal layer formed in the space portions is melted to be formed as unit metal bodies in the light transmissive medium.

18. The method of claim 17, wherein the unit metal bodies are arranged to be spaced apart from each other in the light transmissive medium, as the space portions are spaced apart from each other.
